(19) United States
(12) Patent Application Publication
(10) Pub. No.: US 2017/0009938 A1
(43) Pub. Date: Jan. 12, 2017

(54) LUBRICATION/BLEEDER FITTING

(71) Applicant: PARKER-HANNIFIN CORPORATION, Cleveland, OH (US)

(72) Inventors: Brian W. Cruickshank, Spring, TX (US); Harsh Rajnikant Parekh, Houston, TX (US); Miguel A. Gonzalez, Houston, TX (US)

(73) Assignee: PARKER-HANNIFIN CORPORATION, Cleveland, OH (US)

(21) Appl. No.: 15/115,437

(22) PCT Filed: Mar. 23, 2015
(86) PCT No.: PCT/US2015/022000

§ 371 Date: Jul. 29, 2016

Related U.S. Application Data
(60) Provisional application No. 61/968,910, filed on Mar. 21, 2014.

(51) Int. Cl. F16N 21/02; F16N 29/04

(52) U.S. Cl. CPC F16N 21/02; F16N 29/04; F16N 2200/00; F16N 2260/02

(57) ABSTRACT

A lubrication/bleeder fitting (10) is provided including a cap (14), a body (12) having a first end (15) coupled to the cap, a second end (17) opposite the first end, and an axially extending cavity (40) extending between the first and second ends. The fitting also includes a poppet seat (50) in the axially extending cavity and a poppet (60) disposed in the axially extending cavity and having a nose portion to seat against the poppet seat. A resilient member (64) is disposed in the axially extending cavity between the poppet and the second end, and a spacer (66) is disposed in the axially extending cavity and seating an end of the resilient member opposite the poppet. The poppet is biased in a first position against the poppet seat by the resilient member to prevent fluid flow through the axially extending cavity.

### RELATED APPLICATIONS

This application claims the benefit of/priority to U.S. Provisional Application No. 61/968,910 filed Mar. 21, 2014, which is hereby incorporated herein by reference in its entirety.

### FIELD OF INVENTION

The present invention relates generally to a fitting, and more particularly to a lubrication/bleeder fitting for a well head or valve assembly.

### BACKGROUND

Systems for transfer or storage of fluid often require bleeding of pressure or have internal surfaces requiring lubrication, such as during a typical maintenance activity. The fluid in a typical system is often gas, liquid, or any combination of the two, and may be at a low pressure, a high pressure, or an intermediate pressure therebetween. It may not be possible or convenient to depressurize a system or to disassemble components prior to bleeding pressure or prior to applying lubrication, such as oil, grease, polymer-based lubricant, etc. Thus, fluid systems/devices, such as well heads or valve assemblies, often include fittings for enabling bleeding of pressure from a system/device, such as at high pressure, or for enabling injection of lubrication, such as into a system/device at high pressure. Thus the fitting must be configured to maintain pressure of the associated system/device while performing these activities.

### SUMMARY OF INVENTION

The present invention provides a lubrication/bleeder fitting that overcomes one or more deficiencies of conventional fittings which often seal well only under either high or low pressures and typically have issues maintaining seal under the other of high or low pressures. The lubrication/bleeder fitting according to the present invention enables sealing under both low and high pressures. The present invention also provides a lubrication/bleeder fitting that does not require grease or other lubrication in order to seal, whereby another typical deficiency of conventional fittings can be overcome. Further, the lubrication/bleeder fitting can be constructed to maintain a seal in numerous other severe applications, not limited to high temperature, frequent changes in pressure or temperature, and contact with volatile fluids.

A particular embodiment of a lubrication/bleeder fitting according to the present invention includes a cap and a body coupled to one another. The fitting also includes a poppet seat in an axially extending cavity of the body and a poppet disposed in the axially extending cavity to seat against the poppet seat. A resilient member is disposed in the axially extending cavity between the poppet and a spacer that seats an end of the resilient member opposite the poppet for supporting the resilient member in the axially extending cavity.

The poppet is biased in a first position against the poppet seat by the resilient member to prevent fluid flow through the axially extending cavity. The poppet, resilient member and spacer function together to maintain a seal through the axially extending cavity at both high and low pressures, and even in situations where re-greasing of the fitting has been accidently overlooked. An unseating tool may be inserted into the axially extending cavity to unseat the poppet from the poppet seat to insert lubrication or to bleed pressure through the fitting.

According to a first aspect of the invention, a fitting includes a cap, a body having a first end coupled to the cap, a second end opposite the first end, and an axially extending cavity extending between the first and second ends. A poppet seat in the axially extending cavity, and a poppet is disposed in the axially extending cavity and having a nose portion to seat against the poppet seat. A resilient member is disposed in the axially extending cavity between the poppet and the second end, and a spacer is disposed in the axially extending cavity and seating an end of the resilient member opposite the poppet. The poppet is biased in a first position against the poppet seat by the resilient member to prevent fluid flow through the axially extending cavity.

The cap may include one or more vent holes extending therethrough.

The cap may include an axially extending sealing portion in a cavity of the cap, and wherein the axially extending sealing portion is configured to seat against a cap seat at the first end of the body.

The body may define a shoulder in the axially extending cavity defining the poppet seat.

The fitting may further include a plurality of resilient members in stacked arrangement disposed between the poppet and the spacer in the axially extending cavity.

The plurality of resilient members may be stacked in an alternating arrangement.

The plurality of resilient members may be conical spring washers.

The resilient member may be a conical spring washer.

The poppet may include one or more radially-reduced portions at an outer surface thereof for allowing fluid to flow past an outer periphery of the poppet when the nose portion is unseated from the poppet seat.

A portion of the body at the second end may be pressed radially inward to abut the spacer and secure the spacer in the axially extending cavity.

A fitting assembly may include the fitting in combination with a fluid sensor for sensing fluid that has moved past the poppet seat, the fluid sensor coupled to the fitting and in fluid communication with an intermediate portion of the axially extending cavity disposed between the cap and the poppet seat via a sensor passage extending through the fitting from the sensor to the intermediate portion.

According to another aspect of the invention, a fitting includes a body having a first end, a second end opposite the first end, and an axially extending cavity extending between the first and second ends. The fitting also includes a cap seat at the first end of the body and a cap coupled to the first end and having an axially extending sealing portion extending into the axially extending cavity to seat against the cap seat. A poppet seat in the axially extending cavity is disposed along the axially extending cavity between the cap seat and the second end of the body, and a poppet is disposed in the axially extending cavity and having a nose portion configured to be seated against the poppet seat in the body. A plurality of resilient members is in stacked arrangement in the axially extending cavity biasing the nose portion against the poppet seat. A spacer is disposed in the axially extending cavity seating an end of the stack of resilient members opposite the poppet.

The plurality of resilient members may include conical spring washers stacked in an alternating arrangement.

The cap may include a vent hole extending therethrough from the first end of the body to an external surface of the cap and fluidly separated from the axially extending cavity via seating of the axially extending seating portion against the cap seat.

A fitting assembly may include the fitting in combination with a fluid sensor for sensing fluid that has moved past the poppet seat, the fluid sensor coupled to the body between the first and second ends and in fluid communication through the body with an intermediate portion of the axially extending cavity disposed between the cap seat and the poppet seat via a sensor passage extending through the body from the sensor to the intermediate portion.

A fitting assembly may include the fitting in combination with a fluid sensor for sensing fluid that has moved past the poppet seat, the fluid sensor coupled to the cap and in fluid communication through the cap with an intermediate portion of the axially extending cavity disposed between the cap seat and the poppet seat, via a sensor passage extending through the cap from the sensor to the intermediate portion.

According to yet another aspect of the invention, a fitting includes a cap, and a body having a first end configured for connection to the cap, a second end configured for connection to a fluid device, and an axially extending cavity extending between the first and second ends, wherein the cap is configured to seat against a cap seat at the axially extending cavity at the first end of the body. The fitting further includes a poppet seat in the axially extending cavity, and a plurality of resilient members stacked in the axially extending cavity. The fitting also includes a spacer disposed in the axially extending cavity and configured to seat between the stack of resilient members and the second end of the body. Further included is a poppet disposed in the axially extending cavity and having a nose portion configured to seat with the poppet seat and a base portion configured to engage the stack of resilient members, wherein the poppet is biased in a first position against the poppet seat by the resilient member to prevent fluid flow through the axially extending cavity, and wherein the poppet is movable to a second position against the biasing force of the stack of resilient members to allow fluid flow through the axially extending cavity.

The axially extending cavity may be configured to receive a unseating tool at the first end and to allow engagement of the unseating tool with the poppet to unseat the poppet from the poppet seat to allow fluid flow through the axially extending cavity.

The cap includes a vent hole extending through the cap from the first end of the body to an external surface of the cap, wherein the vent holes are in fluid communication with the axially extending cavity upon unseating of the cap from the cap seat.

A fitting assembly may include the fitting in combination with a fluid sensor for sensing fluid that has moved past the poppet seat prior to disconnection of the cap from the cap seat, the fluid sensor being engageable with the fitting and fluidly connectable to the axially extending cavity between the cap seat and the poppet set.

According to still another aspect of the invention, a method of lubricating a fluid device via a lubrication fitting coupled to the fluid device includes the steps of (a) verifying that no fluid is detected in an axially extending cavity of the fitting extending between a first end of the fitting body threadedly coupled to the cap and to the fuel device at a second end of the fitting body opposite the first end, (b) after the verifying step, inserting an unseating tool into the axially extending cavity, and (c) after inserting the unseating tool, engaging a poppet of the fitting that is seated against a poppet seat of the fitting in the axially extending cavity, where the unseating tool is engaged with the poppet to counter the biasing force of a stack of resilient members biasing the poppet against the poppet seat and disposed in the axially extending cavity between the poppet and a spacer disposed at the second end of the body in the axially extending cavity, where the engagement of the unseating tool and the poppet enables bleeding of pressure from the fluid device or provision of lubricant to the fluid device through the axially extending cavity.

The verifying step may include partially unthreading a cap from the first end of the fitting body to determine if fluid is detected being output from a vent hole extending through the cap from the first end of the fitting body to an external surface of the cap.

The method may further include the step of after partially unthreading the cap, threadedly retightening the cap to the first end of the fitting body if fluid is detected being output from the vent hole.

The method may further include the step of removing the cap from the first end of the fitting body prior to inserting the unseating tool.

The verifying step may include checking a fluid sensor for sensing fluid that has moved past the poppet seat, the fluid sensor coupled to the fitting and in fluid communication with an intermediate portion of the axially extending cavity disposed between the cap and the poppet seat.

The method may further include the step of threadedly coupling the unseating tool to the fitting prior to or while engaging the poppet of the fitting with the unseating tool.

The foregoing and other features of the invention are hereinafter described in greater detail with reference to the accompanying drawings.

### BRIEF DESCRIPTION OF THE DRAWINGS

FIG. 1 is an orthogonal view of an exemplary lubrication/bleeder fitting according to the invention.

FIG. 2 is an end view of the lubrication/bleeder fitting of FIG. 1.

FIG. 3 is a cross-sectional view of the lubrication/bleeder fitting of FIG. 1.

FIG. 4 is another cross-sectional view of the lubrication/bleeder fitting of FIG. 1.

FIG. 5 is an orthogonal view of an exemplary poppet for use in the lubrication/bleeder fitting of FIG. 1.

FIG. 6 is an elevated side view of another exemplary lubrication/bleeder fitting according to the invention.

FIG. 7 is an elevated partial cross-sectional view of the lubrication/bleeder fitting of FIG. 6.

FIG. 8 is an elevated side view of yet another exemplary lubrication/bleeder fitting according to the invention.

FIG. 9 is an elevated partial cross-sectional view of the lubrication/bleeder fitting of FIG. 8.

### DETAILED DESCRIPTION

The principles of the present invention have particular application to lubrication/bleeder fittings for use in a well head or valve assembly used in the transfer or storage of fluid in severe service applications. For example, the lubrication/bleeder fitting may be subject to a fluid at an extreme temperature or at a high pressure, or may be in contact with an abrasive, corrosive, acidic, or otherwise volatile fluid, such as hydrogen sulfide at a high pressure. As used herein, fluid refers to a liquid, a gas, or any combination thereof.

The lubrication/bleeder fitting enables bleeding of pressure from or lubrication of internal areas of the well head or valve assembly without depressurization or disassembly of the well head, valve assembly, or associated system/device. Though the associated system instead may be depressurized or disassembled prior to performing the activity or activities. It will be appreciated that the principles are also applicable to other fluid transfer or storage systems or to systems having fluid transfer or storage portions, and/or may be used with fluids at any of a low pressure, a high pressure, or an intermediate pressure therebetween.

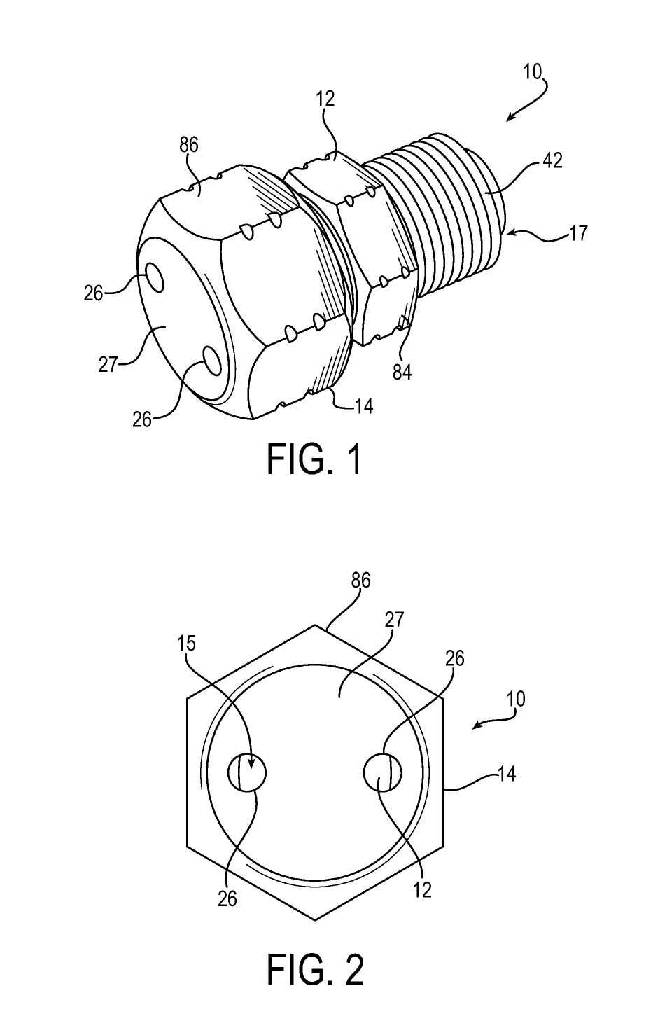

Turning now to FIGS. 1 to 4, an exemplary lubrication/bleeder fitting, also herein referred to as a fitting, is illustrated generally at reference numeral 10. The fitting 10 may be threaded into a fluid device, also herein referred to as a fluid system, such as a well head or valve assembly, to enable lubrication of components of the well head or valve assembly or bleeding of pressure from inside the well head or valve assembly. It will be appreciated that the lubrication/bleeder fitting 10 may also be used with any other assembly having a threaded port and requiring a sealed fitting that enables bleeding of pressure from or lubrication of internal components of the other assembly.

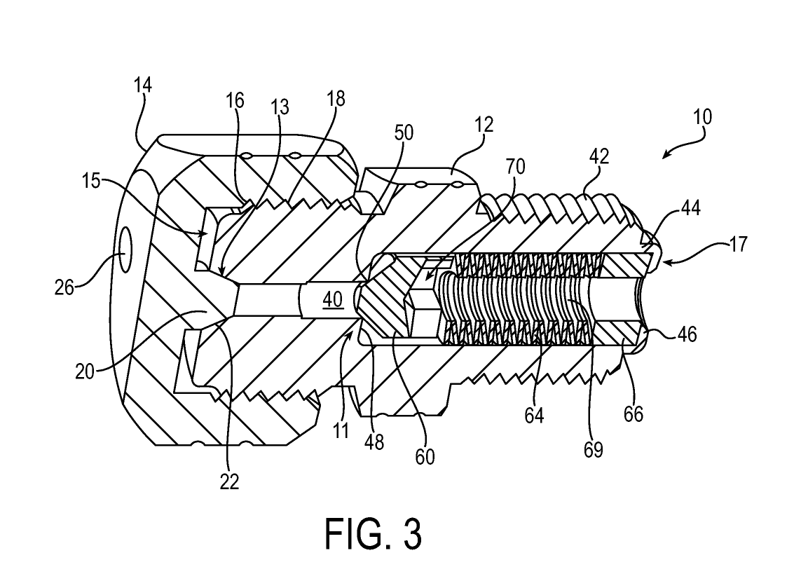

The depicted fitting 10 includes a primary seal 11 (FIG. 3) for maintaining seal against pressure inside the respective well head or valve assembly. A secondary seal 13 (FIG. 3) is also included as a backup to the primary seal 11. The primary seal 11 is included in a fitting body 12, while the secondary seal 13 is generally at the interengagement of the fitting body 12 and a cap 14. At least the primary seal 11 is unseated to enable lubrication or bleeding of the respective well head or valve assembly through the fitting 10.

The secondary seal 13 allows for verification of continued sealing of the primary seal 11 when the secondary seal 13 is first unseated. If pressure is released upon initially unseating the secondary seal 13, an operator is thus notified that the primary seal 11 is compromised and is no longer properly sealing, and the secondary seal 13 should be reseated to maintain closure of the respective well head or valve assembly at a location of the fitting 10.

The lubrication/bleeder fitting 10 may be configured, such as being made of a suitable material, to be used with a variety of liquids, gases, or any combination thereof contained in the respective well head or valve assembly. Exemplary liquids or gases include air, water, etc. Exemplary materials of the fitting 10 include stainless steel, steel composite, etc. The exemplary materials may be hardened materials. The fitting 10 may also be used with any suitable lubricant such as oil, grease, polymer-based lubricant, etc.

The fitting 10 includes a fitting body 12, also herein referred to as a body 12, extending between a first end 15 and a second end 17 disposed opposite the first end 15. The first end 15 is configured for coupling to a closure, such as the cap 14. The second end 17 is configured for coupling to a fluid device, such as a well head or valve assembly. As used herein, coupling may refer to direct or indirect coupling of components.

The fitting body 12 includes an axially extending cavity 40 that extends axially between the first end 15 and the second end 17 to connect at external atmosphere at the first end 15 with an internal chamber of the fluid device at the second end 17. The cavity 40 extends along a longitudinal axis of the fitting body 12, such as a central longitudinal axis 21. The cavity 40 is sealed at the first end 15 of the body 12 via the secondary seal 13, and at an intermediate location of the axially extending cavity 40 disposed between the first end 15 and the second end 17 by the primary seal 11.

For coupling to the fluid device, the body 12 includes threads 42 at the second end 17 for mating with the fluid device. The depicted threads 42 are disposed on a radially outward surface of the body 12 and may be tapered threads or may have any other suitable shape. Any suitable number of threads 42 may be included.

To accomplish the threading of the body 12 to the fluid device, rotational force may be applied to a body tool surface 84 of the body 12. The depicted body tool surface 84 is disposed radially outward of the threads 42 and includes flats, such as in a hexagon shape, for being engaged by a tool, such as a wrench.

For coupling to the cap 14, the body 12 includes cap threads 16 at the first end 15. The cap threads 16 are shaped to mate with corresponding body threads 18 on the body 12. As shown, the cap threads 16 are disposed on a radially inward facing surface of the cap 14 while the corresponding body threads 18 are disposed on a radially outward facing surface at the first end 15 of the body 12. The threads 16 or 18 may be tapered threads or may have any other suitable shape. Any suitable number of corresponding threads 16 and 18 may be used.

To accomplish the threading of the cap 14 to the body 12, the cap 14 includes a cap tool surface 86 to which rotational force may be applied, such as relative to a rotational force applied to the body tool surface 84, to thread the cap threads 16 relative to the body threads 18. The depicted cap tool surface 86 is disposed radially outward of the cap threads 16 and includes flats, such as in a hexagon shape, for being engaged by a tool, such as a wrench.

The cap 14 includes a sealing portion 20, such as a conical sealing portion, that seals against a cap seat 22, such as a correspondingly conical cap seat, at the first end 15 of the body 12. In other embodiments, the sealing portion 20 and/or the cap seat 22 may have any other suitable shape. The depicted cap seat 22 is disposed at an end of the axially extending cavity 40 and at least partially defines the cavity 40. It will be appreciated that in other embodiments, the cap seat 22 may be separate from instead of integral with the body 12.

As depicted, the sealing portion 20 is an axially extending sealing portion that extends axially along a longitudinal axis of the body 12, such as the central longitudinal axis 21, extending between the first end 15 and the second end 17. The depicted sealing portion 20 extends from a cap cavity 23 at an underside of the cap 14 towards the axially extending cavity 40. The cap cavity 23 is at least partially defined by the cap threads 16. As shown, the depicted axially extending sealing portion 20 extends into the axially extending cavity 40 to mate with the cap seat 22 when the cap 14 and body 12 are coupled together.

The secondary seal 13 includes the sealing portion 20 and cap seat 22 of the fitting 10. The secondary seal 13 is preferably a metal to metal seal. It will be appreciated that the sealing portion 20 and cap seat 22 may provide a surface to surface seal as depicted, though the sealing portion 20 and cap seat 22 may be otherwise constructed in other embodiments to provide a line seal.

Further, in some embodiments a resilient member, such as an o-ring or other gasket, may be provided between the cap 14 and the first end 15, such as between the first end 15 and an internal surface 25 of the cap 14, to provide for additional sealing. In such case, the resilient member may be retained in a groove, such as a dovetail-shaped groove, at either of the first end 15 or internal surface 25. As depicted, the cap cavity 23 is partially defined by the internal surface 25.

The cap 14 has one or more vents 26, also herein referred to as vent holes, extending through the cap 14 from the internal surface 25 to an opposing external surface 27. When the cap 14 is coupled to the body 12, the vents 26 extend between the first end 15 and the external surface 27 and the vents 26 are fluidly separated from the axially extending cavity 40 via the seated secondary seal 13.

While the vents 26 are depicted as having a generally cylindrical shape, the vents 26 may instead have any suitable shape. Further, while two vents 26 are included, any suitable number of vents 26, one or more, may be used. The vents 26 may not be parallel to one another as shown and/or may extend to any suitable external surface of the cap 14.

The vents 26 are included in the cap 14 as an indication feature for assisting in warning an operator that the primary seal 11 has been compromised. For example, the cap 14 is at least partially unthreaded from the body 12 to unseat the secondary seal 13, i.e., to unseat the sealing portion 20 from the cap seat 22. In this way, the vents 26 are put into fluid communication with the axially extending cavity 40. If fluid leaks through the one or more vents 26, the leakage will notify an operator that the primary seal 11 has been compromised and that the cap 14 should be rethreaded onto the body 12 to reseat the secondary seal 13.

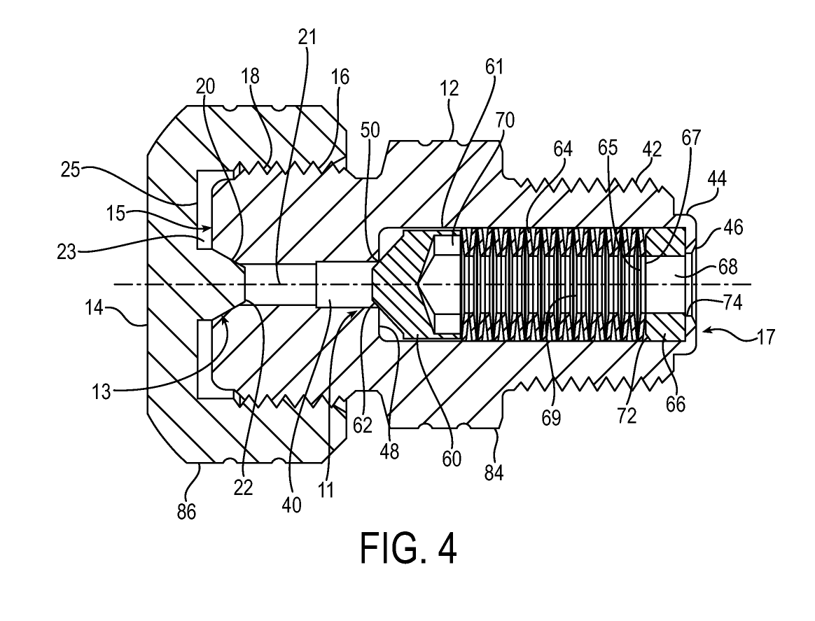

Turning specifically to FIGS. 3 and 4, the body 12 includes a poppet seat 50 defined by a shoulder 48 in the axially extending cavity 40. Thus the poppet seat 50 is in the axially extending cavity 40. It will be appreciated that in other embodiments, the poppet seat 50 may be separate from instead of integral with the body 12.

Disposed in the axially extending cavity 40 is a poppet 60. The poppet 60 has a generally cylindrical outer surface 61 for mating with a generally cylindrical inner surface 63 of the axially extending cavity 40. The poppet 60 includes a nose portion 62 configured for seating against the poppet seat 50. The depicted nose portion 62 is as a conical nose portion, though in other embodiments, the poppet 60 or the nose portion 62 of the poppet 60 may have any other suitable shape.

As shown, the poppet 60 and the poppet seat 50 generally form a line seal. The poppet 60 may be made of metal, such as hardened metal. The poppet 60 and the poppet seat 50 are included in the primary seal 11 of the fitting 10, which is preferably a metal to metal seal. It will be appreciated that the poppet 60 and the poppet seat 50 may be otherwise constructed to provide a surface to surface seal in other embodiments.

Further, in some embodiments a resilient member, such as an o-ring or other gasket, may be provided between the poppet 60 and the poppet seat 50 to provide for additional sealing. In such case, the resilient member may be retained in a groove, such as a dovetail-shaped groove, at either of the poppet 60 or the poppet seat 50.

Also disposed in the axially extending cavity 40 is a resilient member 64 for applying a biasing force to bias the poppet 60 against the poppet seat 50 to prevent fluid flow through the axially extending cavity 40 between the first and second ends 15 and 17. The resilient member 64 is configured, such as shaped, to compress upon application of a compression force, such as to the poppet 60, to enable unseating of the poppet 60 from the poppet seat 50. The resilient member 64 may have any suitable length along the longitudinal axis 21 for use with the poppet 60, and may have any suitable width, such as conforming to the inner surface 63 of the axially extending cavity 40.

One end of the resilient member 64 is seated towards a base end 70 of the poppet 60 opposite the nose portion 62. Another end of the resilient member 64 is seated towards a first end 72 of the spacer 66. Additionally, a member fluid passage 69 extends through the resilient member 64, such as along the longitudinal axis 21, to enable passage of fluid through the axially extending cavity 40 through the member fluid passage 69. Though, it will be appreciated that some fluid may also flow about an outer periphery of the resilient member 64.

The depicted resilient member 64 is a biasing member such a conical spring washer, also known as a coned-disc spring washer, a Belleville washer, or cupped spring washer. The conical spring washer generally has a base end 65 opposite a conical nose end 67.

As depicted, the fitting 10 includes a plurality of the resilient members 64 arranged in a stacked arrangement disposed between the poppet 60 and the second end 17 of the body 12. Any suitable number of resilient members 64 may be used. Preferably, the resilient members 64 are arranged in an alternating stacked arrangement. Thus in the case of conical spring washers, the washers are alternated such that base ends 65 of adjacent washers abut one another, and likewise, nose ends 67 of adjacent washers also abut one another.

A spring support, such as a spacer 66, is also disposed in the axially extending cavity 40 and is configured for supporting the resilient member 64, such as at the first end 72 of the spacer 66. Thus, the depicted spacer 66 abuts the stack of resilient members 64. The depicted spacer 66 is disposed at the second end 17 of the body 12, and is thus configured for engaging the second end 17 of the body 12, such as at a second end 74 of the spacer 66 opposite the first end 72. The spacer 66 provides a more secure primary seal 11 of the fitting 10 than if the stack of resilient members 64 abutted the second end 17 directly. Accordingly, the plurality of resilient members 64 are intermediately disposed between the poppet 60 and the spacer 66.

Like the resilient members 64, the spacer 66 has a spacer fluid passage 68 extending therethrough, such as along the longitudinal axis 21, to enable passage of fluid through the axially extending cavity 40 through the spacer fluid passage 68. Though, it will be appreciated that some fluid may also flow about an outer periphery of the spacer 66.

The poppet 60, resilient member 64, and spacer 66 are retained in the axially extending cavity 40, such as after insertion into the cavity 40, via an engagement portion 46 at the second end 17 of the body 12. The engagement portion 46 is shown as integral with the body 12, though may be separately coupled to the body 12 in other embodiments. The depicted engagement portion 46 is pressed inwardly, such as radially inwardly, such as to abut one end of the spacer 66. The pressing may include crimping, rolling, swaging, or any other suitable method to form the depicted engagement portion 46.

Although described as separate components, it will be appreciated that any of the poppet 60, resilient member 64, and spacer 66 may be a one-piece integral assembly. Each of the poppet 60, resilient member 64, and spacer 66 may be made of any suitable material. For example, the poppet 60 may be made of a hardened metal, such as hardened steel.

Via the interengagement of the poppet 60, the resilient member 64, the spacer 66, and the body 12, the poppet 60 is enabled to self-seal against the cap seat 50. The fitting 10 does not require a tool be inserted into the fitting 10, such as into the axially extending cavity 40, to engage the poppet 60 to cause seating of the poppet 60 against the cap seat 50. Further, the primary seal 11 is constructed to self-seal even under low pressure, such as low pressure in the fluid device.

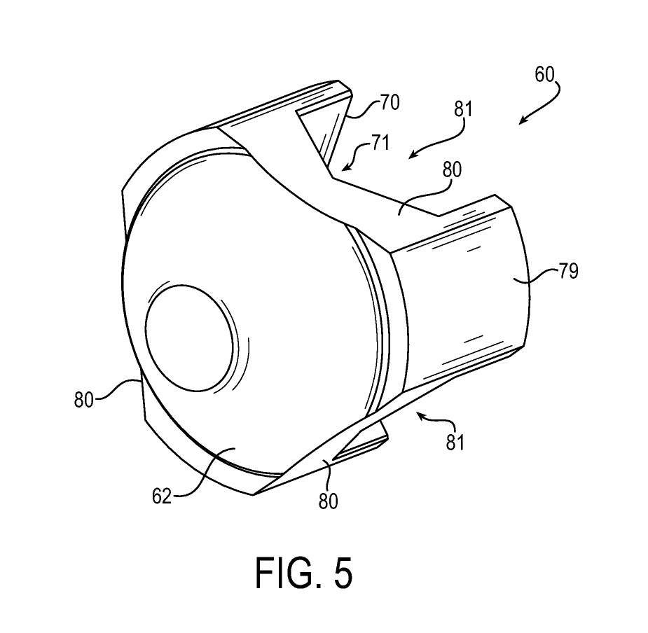

Turning to FIG. 5, the poppet 60 is configured, such as at the base end 70, for mating with the resilient member 64. A poppet chamber 71 is disposed at the base end 70, extending into the base end 70. Extending, such as axially, from the base end 70 to the nose portion 62 are one or more radially-reduced portions 80 at an outer periphery of the poppet 60. The radially-reduced portions 80, such as flats, are disposed at a radially outward outer surface of the poppet 60 relative to the longitudinal axis 21.

The radially-reduced portions 80 generally extend through the poppet 60 at the base end 70 such that the base end 70 has axially extending supports, such as poppet legs 79, for engaging the resilient member 64. The poppet legs 79 at least partially define the poppet chamber 71 and are not circumferentially continuous about the longitudinal axis 21.

Together, the poppet legs 79 and radially-reduced portions 80 form bypass spaces 81 between the poppet legs 79. The bypass spaces 81 are connected to the poppet chamber 71. Accordingly, fluid from the fluid device may enter the second end 17 of the body 12, flow into the axially extending cavity 40 and past the spacer 66 and resilient member 64, such as through the member fluid passages 69 and spacer fluid passage 68, respectively, towards the primary seal 11 and the poppet chamber 71 of the poppet 60. When the nose portion 62, and thus the poppet 60, is not biased against the poppet seat 50, the fluid may continue to flow from the poppet chamber 71 through the bypass spaces 81 and about a periphery of the poppet 60, past the poppet seat 50, and towards the secondary seal 13.

Turning now to all of the FIGS. 1-5, during use, pressure in the fluid device is prevented from escaping through the fitting 10 by the primary seal 11 formed by the nose portion 62 and the poppet seat 50 and by the secondary seal 13 formed by the sealing portion 20 and the cap seat 22. To bleed pressure from or lubricate components of the fluid device, the cap 14 is unthreaded from the body 12 unseating the secondary seal 13, and fluid is prevented from leaking from the fitting 10 by the primary seal 11.

To enable the bleeding or lubrication, the axially extending cavity 40 is configured to receive an unseating tool, such as a stinging tool. The unseating tool may have threads for engaging the fitting 10. For example, once the cap 14 is removed from the body 12, the unseating tool may be threaded to the body threads 18. Via coupling to the body 12, the unseating tool may be engaged with the poppet 60, such as once the unseating tool is securely engaged to the fitting 10, such as to maintain pressure within the fluid device. Though, in other embodiments, the unseating tool may have a moveable portion that is moved to engage the poppet 60 once the unseating tool is securely engaged to the fitting 10, to maintain pressure within the fluid device.

Generally, at least a portion of the unseating tool may be advanced through the axially extending cavity 40 towards the poppet 60, such as past the cap seat 22 and the poppet seat 50. The unseating tool engages the nose portion 62 of the poppet 60, thereby applying a counter force to counter the biasing force of the resilient member 64, compressing the resilient member 64 and unseating the nose portion 62 from the seat 50. The fluid device may then be at least partially bled of pressure through the unseating tool. A high pressure hose may be attached to the unseating tool to receive the bled pressure.

Additionally or alternatively, lubricant can then be injected from the unseating tool into the axially extending cavity 40, such as through the unseating tool. Generally, the lubricant flows through the cavity 40 around poppet 60 via the radially-reduced portions 80, past the resilient member 64 and the spacer 66, where the lubricant exits the second end 17 of the body 12 and enters the fluid device. A lubricant application tool, such as a grease gun, may be attached to the unseating tool to provide the lubricant.

When the unseating tool is removed, the resilient member 64 urges the poppet 60 towards the first end 15 of the body 12, thereby seating the nose portion 62 against the seat 50, sealing the primary seal 11. In the depicted embodiment, the cap 14 may then be threaded onto the body 12 until the sealing portion 20 seats against the cap seat 22, sealing the secondary seal 13.

The invention also includes a method of lubricating a fluid device via the lubrication fitting 10 coupled to the fluid device. The method comprises the steps of (a) verifying that no fluid is detected in the axially extending cavity 40 of the fitting 10 extending between the first end 15 of the fitting body 12 threadedly coupled to the cap 14 and to the fuel device at a second end 17 of the fitting body 12 opposite the first end 15; (b) after the verifying step, inserting an unseating tool into the axially extending cavity 40 of the fitting 10; and (c) after inserting the unseating tool, engaging the unseating tool with the poppet 60 of the fitting 10 that is seated against the poppet seat 50 of the fitting 10 in the axially extending cavity 40, where the unseating tool is engaged with the poppet 60 to counter the biasing force of a stack of resilient members 64 biasing the poppet 60 against the poppet seat 50 and disposed in the axially extending cavity 40 between the poppet 60 and a spacer 66 disposed at the second end 17 of the body 12 in the axially extending cavity 40, where the engagement of the unseating tool and the poppet enables bleeding of pressure from the fluid device or provision of lubricant to the fluid device through the axially extending cavity 40. Additionally, the injecting lubrication step includes injecting lubrication through the unseating tool.

The verifying step includes partially unthreading the cap 14 from the first end 15 of the fitting body 12 to determine if fluid is detected being output from a vent hole 26 extending through the cap 14 from the first end 15 of the fitting body 12 to an external surface 27 of the cap 14. After partially unthreading the cap 14, the method further includes threadedly retightening the cap 14 to the first end 15 of the fitting body 12 if fluid is detected being output from the vent hole 26.

The method may also include the step of removing the cap 14 from the first end 15 of the fitting body 12 prior to inserting the unseating tool. The method may further include the step of threadedly coupling the unseating tool to the fitting 10 prior to or while engaging the poppet 60 of the fitting 10 with the unseating tool.

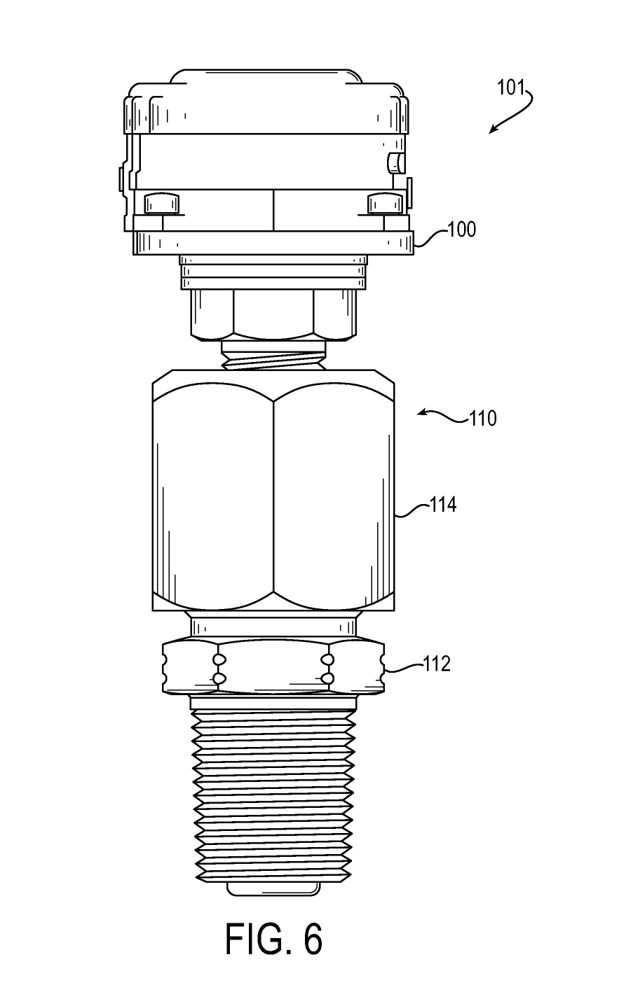

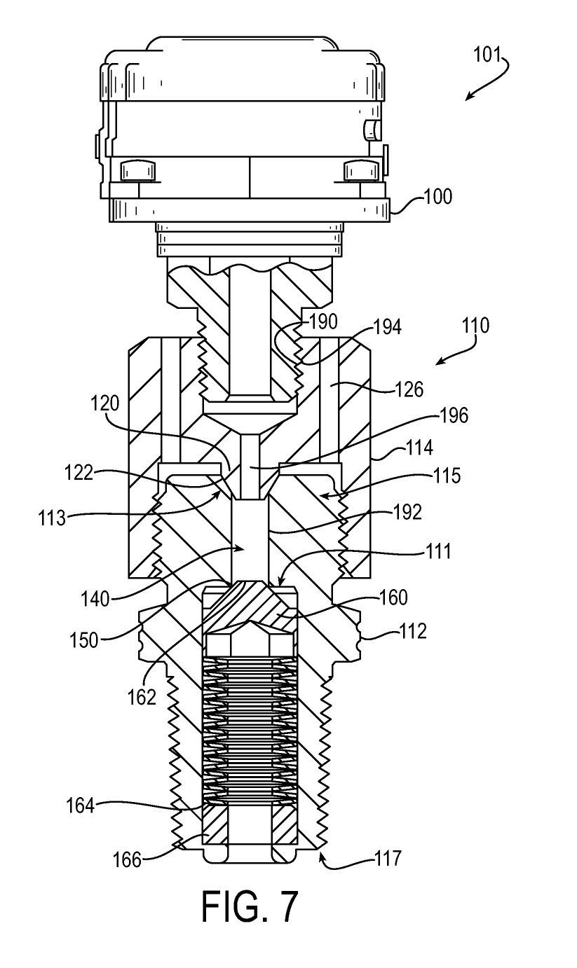

Turning now to FIGS. 6 and 7, an exemplary embodiment of the fitting is shown at 110. The fitting 110 is substantially the same as the above-referenced fitting 10, and consequently the same reference numerals but indexed by 100 are used to denote structures corresponding to similar structures in the fitting 110. In addition, the foregoing description of the fitting 10 is equally applicable to the fitting 110 except as noted below. Moreover, it will be appreciated upon reading and understanding the specification that aspects of the fittings 10 and 110 may be substituted for one another or used in conjunction with one another where applicable.

The fitting 110 is shown as part of a fitting assembly 101 including the fitting 110 and a fluid sensor 100. The fluid sensor 100 is provided for sensing fluid that has moved past the poppet seat 150, and thus past the primary seal 111 towards the first end 115. The fluid sensor 100 may be constructed to sense a fluid parameter such as pressure, vibration, temperature, moisture, or chemical composition in the axially extending cavity 140.

The fluid sensor 100 may be wired or wirelessly communicatively connected to a display device for displaying the fluid parameter. In other embodiments, the fluid sensor 100 may include a display for displaying the fluid parameter. In any case, the display may be a digital readout, color change indicator, or any other suitable indicator for aiding an operator in identifying presence of fluid indicating that the primary seal 111 has been compromised.

The fluid sensor 100 is coupled to the fitting 110, such as threadedly coupled via fitting threads 190. As shown, the depicted fluid sensor 100 is coupled to the fitting 110, such as to the cap 114, for continuous fluid communication with an intermediate portion 192 of the axially extending cavity 140 between the cap 114 and the poppet seat 150, and more preferably between the poppet seat 150 and the cap seat 122. The depicted fluid sensor 100 is axially aligned with the axially extending cavity 140, though may be otherwise oriented in other embodiments.

The cap 114 includes threads 194 for engaging the fitting threads 190. Additionally, a sensor passage 196 extends through the cap 114 from the first end 115 to an external surface of the cap 114 for enabling the continuous communication of the fluid sensor 100 with the intermediate portion 192.

In use of the fitting assembly 101, the sensor 100 may provide indication to an operator that the primary seal 111 has been compromised prior to the operator removing the sensor 100 or unseating the secondary seal 113 to determine via unseating of the use of the vents 126 if the primary seal 111 has been compromised. In this way, the operator may not be accidently exposed to a volatile gas in the associated fluid device that is vented through the vents 126 where the primary seal 111 is compromised and the secondary seal 113 is unsealed.

Accordingly, the cap 114 may or may not be removed prior to insertion of an unseating tool into the axially extending cavity 140. Where the fluid sensor 100 is removed from the cap 114 and the cap 114 is not removed, the unseating tool may be inserted through the sensor passage 192 and coupled to the cap 114, such as to the threads 194. Alternatively, the cap 114 may be removed prior to insertion of the unseating tool.

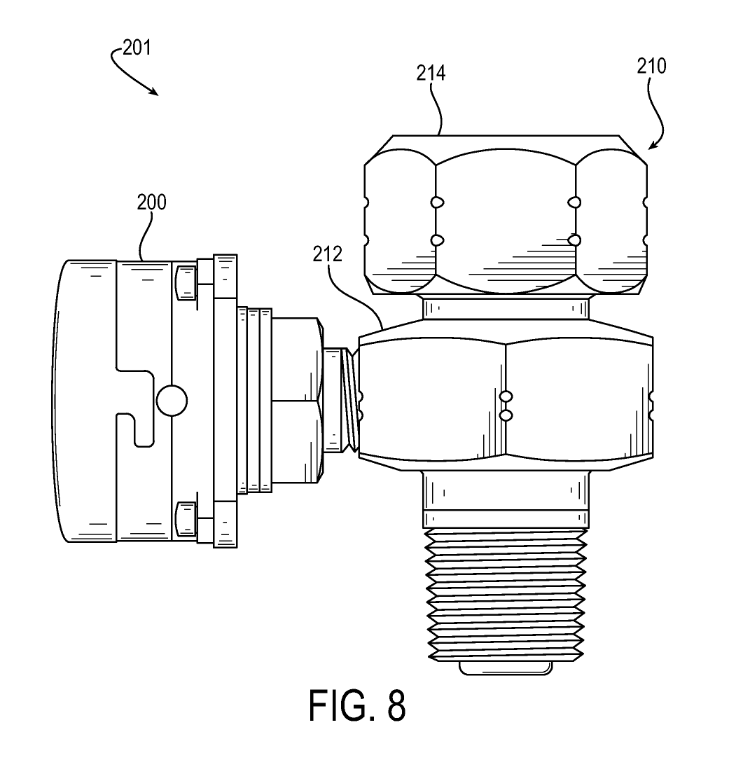

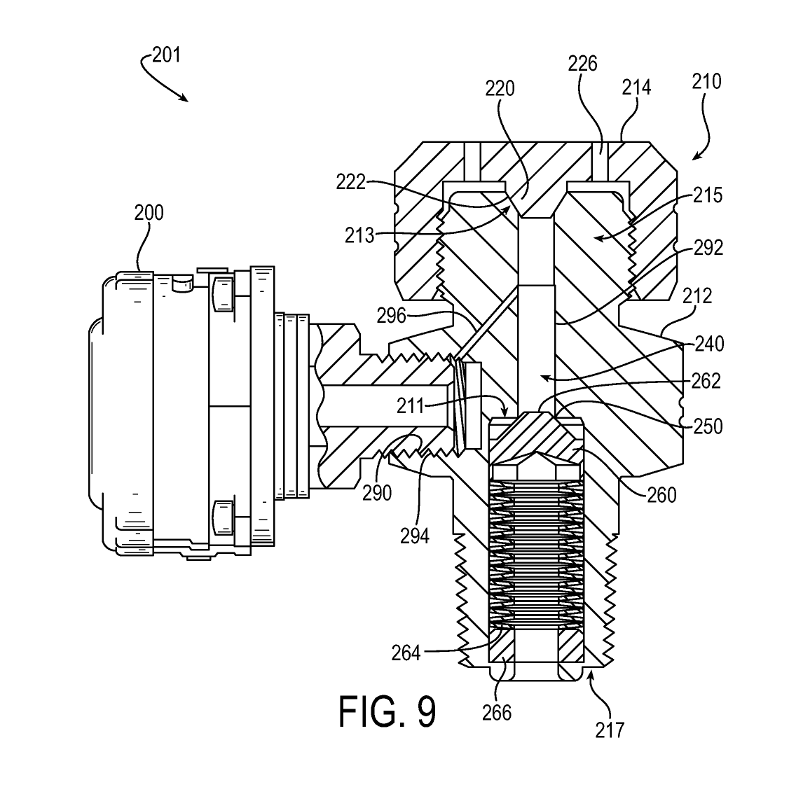

Turning next to FIGS. 8 and 9, an exemplary embodiment of the fitting is shown at 210. The fitting 210 is substantially the same as the above-referenced fittings 10 and 110, and consequently the same reference numerals but indexed by 100 are used to denote structures corresponding to similar structures in the fitting 210. In addition, the foregoing descriptions of the fittings 10 and 110 are equally applicable to the fitting 210 except as noted below. Moreover, it will be appreciated upon reading and understanding the specification that aspects of the fittings 10, 110 and 210 may be substituted for one another or used in conjunction with one another where applicable.

The fitting 210 is shown as part of a fitting assembly 201 including the fitting 210 and a fluid sensor 200. The fluid sensor 200 is provided for sensing fluid that has moved past the poppet seat 250, and thus past the primary seal 211 towards the first end 215. The fluid sensor 200 may be constructed to sense a fluid parameter such as pressure, vibration, temperature, moisture, or chemical composition in the axially extending cavity 240.

The fluid sensor 200 may be wired or wirelessly communicatively connected to a display device for displaying the fluid parameter. In other embodiments, the fluid sensor 200 may include a display for displaying the fluid parameter. In any case, the display may be a digital readout, color change indicator, or any other suitable indicator for aiding an operator in identifying presence of fluid indicating that the primary seal 211 has been compromised.

The fluid sensor 200 is coupled to the fitting 210, such as threadedly coupled via fitting threads 290. As shown, the depicted fluid sensor 200 is coupled to the fitting 210, such as to the body 212, for continuous fluid communication with an intermediate portion 292 of the axially extending cavity 240 between the cap 214 and the poppet seat 250, and more preferably between the poppet seat 250 and the cap seat 222. The depicted fluid sensor 200 is orthogonally aligned with respect to the axially extending cavity 240, though may be otherwise oriented in other embodiments.

The body 212 includes threads 294 for engaging the fitting threads 290. Additionally, a sensor passage 296 extends through the body 212 from the axially extending cavity 240 to an external surface of the body 212, and more preferably from the intermediate portion 292 to the external surface of the body 212, for enabling the continuous communication of the fluid sensor 200 with the intermediate portion 292.

In use of the fitting assembly 201, the sensor 200 may provide indication to an operator that the primary seal 211 has been compromised prior to the operator removing the sensor 200 or unseating the secondary seal 213 to determine via use of the vents 226 if the primary seal 211 has been compromised. In this way, the operator may not be accidently exposed to a volatile gas in the associated fluid device that is vented through the vents 226 where the primary seal 211 is compromised and the secondary seal 213 is unsealed.

Accordingly, in the embodiment of FIGS. 8 and 9, the cap 214 is removed prior to insertion of an unseating tool into the axially extending cavity 240. Where the fluid sensor 200 is removed from the body 212, the sensor passage 296 will need to be sealed from the external environment before insertion of the unseating tool and unseating of the primary seal 211.

With respect to the embodiments of FIGS. 6 to 9, the method described with respect to the embodiment of FIGS. 1 to 5 is generally applicable. Though as mentioned, in the embodiment of FIGS. 6 and 7, it is not necessary to remove the cap 114 prior to inserting the unseating tool and engaging the unseating tool to the fitting 110 if the unseating tool may be engaged to the cap 114, such as to the threads 194, rather than to the first end 115 of the body 112. Accordingly, the verifying step of the method applicable to FIGS. 6 to 9 includes checking a fluid sensor 100/200 for sensing fluid that has moved past the poppet seat 150/250, the fluid sensor 100/200 being coupled to the fitting 110/210 and in fluid communication with an intermediate portion 192/292 of the axially extending cavity 140/240 disposed between the cap 114/214 and the poppet seat 150/250.

In summary, a lubrication/bleeder fitting 10/110/210 includes a cap 14/114/214, a body 12/112/212 having a first end 15/115/215 coupled to the cap 14/114/214, a second end 17/117/217 opposite the first end 15/115/215, and an axially extending cavity 40/140/240 extending between the first and second ends 15/115/215 and 17/117/217. The fitting 10/110/210 also includes a poppet seat 50/150/250 in the axially extending cavity 40/140/240 and a poppet 60/160/260 disposed in the axially extending cavity 40/140/240 and having a nose portion 62/162/262 to seat against the poppet seat 50/150/250. A resilient member 64/164/264 is disposed in the axially extending cavity 40/14/240 between the poppet 60/160/260 and the second end 17/117/217, and a spacer 66/166/266 is disposed in the axially extending cavity 40/140/240 and seating an end of the resilient member 64/164/264 opposite the poppet 60/160/260. The poppet 60/160/260 is biased in a first position against the poppet seat 50/150/250 by the resilient member 64/164/264 to prevent fluid flow through the axially extending cavity 40/14/240.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A fitting comprising:
a cap;
a body having a first end coupled to the cap, a second end opposite the first end, and an axially extending cavity extending between the first and second ends;
a poppet seat in the axially extending cavity;
a poppet disposed in the axially extending cavity and having a nose portion to seat against the poppet seat;
a resilient member disposed in the axially extending cavity between the poppet and the second end; and
a spacer disposed in the axially extending cavity and seating an end of the resilient member opposite the poppet,
wherein the poppet is biased in a first position against the poppet seat by the resilient member to prevent fluid flow through the axially extending cavity.

2. The fitting of claim 2, wherein the cap includes one or more vent holes extending therethrough.

3. The fitting of claim 1 or of any of claim 1 or 2, wherein the cap includes an axially extending sealing portion in a cavity of the cap, and wherein the axially extending sealing portion is configured to seat against a cap seat at the first end of the body.

4. The fitting of claim 1 or of any of claims 1 to 3, wherein the body defines a shoulder in the axially extending cavity defining the poppet seat.

5. The fitting of claim 1 or of any of claims 1 to 4, wherein the fitting further includes a plurality of resilient members in stacked arrangement disposed between the poppet and the spacer in the axially extending cavity.

6. The fitting of claim 5, wherein the plurality of resilient members are stacked in an alternating arrangement.

7. The fitting of claim 6, wherein the plurality of resilient members are conical spring washers.

8. The fitting of claim 1 or of any of claims 1 to 7, wherein the resilient member is a conical spring washer.

9. The fitting of claim 1 or of any of claims 1 to 8, wherein the poppet includes one or more radially-reduced portions at an outer surface thereof for allowing fluid to flow past an outer periphery of the poppet when the nose portion is unseated from the poppet seat.

10. The fitting of claim 1 or of any of claims 1 to 9, wherein a portion of the body at the second end is pressed radially inward to abut the spacer and secure the spacer in the axially extending cavity.

11. A fitting assembly including the fitting of claim 1 or of any of claims 1 to 10, in combination with a fluid sensor for sensing fluid that has moved past the poppet seat, the fluid sensor coupled to the fitting and in fluid communication with an intermediate portion of the axially extending cavity disposed between the cap and the poppet seat via a sensor passage extending through the fitting from the sensor to the intermediate portion.

12. A fitting comprising:
a body having a first end, a second end opposite the first end, and an axially extending cavity extending between the first and second ends;
a cap seat at the first end of the body;
a cap coupled to the first end and having an axially extending sealing portion extending into the axially extending cavity to seat against the cap seat;
a poppet seat in the axially extending cavity disposed along the axially extending cavity between the cap seat and the second end of the body;
a poppet disposed in the axially extending cavity and having a nose portion configured to be seated against the poppet seat in the body;
a plurality of resilient members in stacked arrangement in the axially extending cavity and biasing the nose portion against the poppet seat; and
a spacer disposed in the axially extending cavity and seating an end of the stack of resilient members opposite the poppet.

13. The fitting of claim 12, wherein the plurality of resilient members include conical spring washers stacked in an alternating arrangement.

14. The fitting of claim 12 or of any of claims 1 to 13, wherein the cap includes a vent hole extending therethrough from the first end of the body to an external surface of the cap and fluidly separated from the axially extending cavity via seating of the axially extending seating portion against the cap seat.

15. A fitting assembly including the fitting of claim 12 or of any of claims 1 to 14, in combination with a fluid sensor for sensing fluid that has moved past the poppet seat, the fluid sensor coupled to the body between the first and second ends and in fluid communication through the body with an intermediate portion of the axially extending cavity disposed between the cap seat and the poppet seat via a sensor passage extending through the body from the sensor to the intermediate portion.

16. A fitting assembly including the fitting of claim 12 or of any of claims 1 to 14, in combination with a fluid sensor for sensing fluid that has moved past the poppet seat, the fluid sensor coupled to the cap and in fluid communication through the cap with an intermediate portion of the axially extending cavity disposed between the cap seat and the poppet seat, via a sensor passage extending through the cap from the sensor to the intermediate portion.

17. A fitting comprising:
a cap;
a body having a first end configured for connection to the cap, a second end configured for connection to a fluid device, and an axially extending cavity extending between the first and second ends, wherein the cap is configured to seat against a cap seat at the axially extending cavity at the first end of the body;
a poppet seat in the axially extending cavity;
a plurality of resilient members stacked in the axially extending cavity;
a spacer disposed in the axially extending cavity and configured to seat between the stack of resilient members and the second end of the body; and
a poppet disposed in the axially extending cavity and having a nose portion configured to seat with the poppet seat and a base portion configured to engage the stack of resilient members, wherein the poppet is biased in a first position against the poppet seat by the resilient member to prevent fluid flow through the axially extending cavity, and wherein the poppet is movable to a second position against the biasing force of the stack of resilient members to allow fluid flow through the axially extending cavity.

18. The fitting of claim 17 or of any of claims 1 to 17, wherein the axially extending cavity is configured to receive a unseating tool at the first end and to allow engagement of the unseating tool with the poppet to unseat the poppet from the poppet seat to allow fluid flow through the axially extending cavity.

19. The fitting of claim 17 or of any of claims 1 to 18, wherein the cap includes a vent hole extending through the cap from the first end of the body to an external surface of the cap, wherein the vent holes are in fluid communication with the axially extending cavity upon unseating of the cap from the cap seat.

20. A fitting assembly including the fitting of claim 17 or of any of claims 1 to 19, in combination with a fluid sensor for sensing fluid that has moved past the poppet seat prior to disconnection of the cap from the cap seat, the fluid sensor being engageable with the fitting and fluidly connectable to the axially extending cavity between the cap seat and the poppet set.

21. A method of lubricating a fluid device via a lubrication fitting coupled to the fluid device, the method comprising the steps of:
verifying that no fluid is detected in an axially extending cavity of the fitting extending between a first end of the fitting body threadedly coupled to the cap and to the fuel device at a second end of the fitting body opposite the first end;
after the verifying step, inserting an unseating tool into the axially extending cavity; and
after inserting the unseating tool, engaging a poppet of the fitting that is seated against a poppet seat of the fitting in the axially extending cavity, where the unseating tool is engaged with the poppet to counter the biasing force of a stack of resilient members biasing the poppet against the poppet seat and disposed in the axially extending cavity between the poppet and a spacer disposed at the second end of the body in the axially extending cavity, where the engagement of the unseating tool and the poppet enables bleeding of pressure from the fluid device or provision of lubricant to the fluid device through the axially extending cavity.

22. The method of claim 21, wherein the verifying step includes partially unthreading a cap from the first end of the fitting body to determine if fluid is detected being output from a vent hole extending through the cap from the first end of the fitting body to an external surface of the cap.

23. The method of claim 22, further including the step of after partially unthreading the cap, threadedly retightening the cap to the first end of the fitting body if fluid is detected being output from the vent hole.

24. The method of claim 22, further including the step of removing the cap from the first end of the fitting body prior to inserting the unseating tool.

25. The method of claim 21 or of any of claims 21 to 24, wherein the verifying step includes checking a fluid sensor for sensing fluid that has moved past the poppet seat, the fluid sensor coupled to the fitting and in fluid communication with an intermediate portion of the axially extending cavity disposed between the cap and the poppet seat.

26. The method of claim 21 or of any of claims 21 to 25, further including the step of threadedly coupling the unseating tool to the fitting prior to or while engaging the poppet of the fitting with the unseating tool.
